(19) United States
(12) Patent Application Publication
(10) Pub. No.: US 2022/0379755 A1
(43) Pub. Date: Dec. 1, 2022

(54) Electric Vehicle Charger for Commercial Installation

(71) Applicants: David Tanner, Avon, CT (US); David Bairamian, Bogota, NJ (US); Matthew Leff, New York, NY (US); Paul Iannacone, North Wantagh, NY (US)

(72) Inventors: David Tanner, Avon, CT (US); David Bairamian, Bogota, NJ (US); Matthew Leff, New York, NY (US); Paul Iannacone, North Wantagh, NY (US)

(21) Appl. No.: 17/829,250

(22) Filed: May 31, 2022

Related U.S. Application Data
(60) Provisional application No. 63/194,686, filed on May 28, 2021.

(51) Int. Cl. B60L 53/30; B60L 53/31; B60L 53/18; G06Q 20/40

(52) U.S. Cl. CPC B60L 53/305; B60L 53/31; B60L 53/18; G06Q 20/401; H02J 2207/20

(57) ABSTRACT

Disclosed is a charger for an electric vehicle suitable for commercial installation having a main body, an electrical usage meter on the main body configured to meter three-phase power, a main three-phase circuit breaker, a transformer in the main body, the transformer configured to step-up the voltage of the three-phase power, and a main single-phase circuit breaker.

This application is a non-provisional of U.S. Provisional Application 63/194,686 filed May 28, 2021, the entirety of which is hereby incorporated by reference.

### BACKGROUND OF THE INVENTION

### Field of the Invention

The embodiments of the invention relate to battery chargers, and more particularly, to a battery charger for electric vehicles. Although embodiments of the invention are suitable for a wide scope of applications, it is particularly suitable for commercial charging of electric vehicles from a three-phase power source of varying voltage.

### Discussion of the Related Art

The art of electric vehicle charging consists primarily of “Level 1,” “Level 2,” and “Level 3” chargers. Level 1 chargers in the United States are configured to operate on standard household voltages—usually at 120 volts AC at 12 to 20-amps. Charging the battery of an electric vehicle using a Level 1 charger can take upwards of 30-60 hours due to the limited energy available through ordinary household outlets. Level 2 chargers are configured to operate at higher 208 or 240 volts AC and up to 80-amps delivering considerably more energy. A Level 2 charger can charge an electric vehicle in as quickly as 3-12 hours. A Level 2 charger is ideally configured to operate at 240 v AC split-phase and 240 v AC split-phase is commonly available in residential settings. Level 3 chargers differ from Level 1 and 2 in that a Level 3 charger converts AC to DC power then directly feeds the DC power into a vehicle battery. Level 3 chargers generally operate on 480 vac three-phase AC commonly found in industrial environments.

Level 2 chargers can function at a variety of voltages, but are optimally operated at 240 v or higher. 240 v AC split-phase is commonly available in residential settings. However, the common voltage available in commercial property environments is 208 v three-phase. The lower voltage and utilization of two legs of the three-phase feed result in a 15-20% operating inefficiency at the same amperage. This causes many 32-amp Level 2 chargers to be underpowered and perform as though they were 26-amp chargers; 40-amp chargers to perform as 32-amp chargers; 48-amp chargers to perform as 40-amp chargers, etcetera. Accordingly, Level 2 chargers in such common commercial environments and 208 v multifamily residential environments do not charge an electric vehicle as quickly as if they were attached to a 240 volt power source.

There are also logistical and regulatory problems with common commercial, and commercial multi-family, electric vehicle charging. First, commercial chargers commonly receive electricity through a dedicated service including a dedicated utility billing meter from the utility company. Installation of the utility meter, and other components necessary and desirable for vehicle charging such as the main shutoff, transformer, overcurrent protection circuit breakers, and other components require construction infrastructure such as a unistrut framework, multiple conduits, and additional foundations for electrical cabinets. This additional infrastructure is commonly assembled by electricians in the field at considerable time and expense, with such field-assembly resulting in errors otherwise avoided if assembled in a controlled factory.

Second, local municipalities commonly regulate the erection and installation of equipment through zoning regulation and safety codes. For example, if an electrical component, a county may require a permit to pour a concrete pad, a permit to erect an electrical box to house equipment, and electrical permits to connect the equipment. As the equipment requirements to charge electric vehicles becomes more complex, additional permits, planning, and paper work is required to successfully install a vehicle charger—thereby increasing costs.

Third, the aforementioned infrastructure can take up considerable space, require expanded scope of permits and documentation, create an eyesore, increase the time required to install a commercial vehicle charger, and conflict with minimum setback regulations that otherwise do not apply to utility-required or utility-owned electrical equipment.

Fourth, DC chargers can be problematic to install in commercial environments as the need for a 480 volt feed can require a step-up transformer, and in the inverse, Level 2 chargers can be difficult to install in or adjacent to industrial environments and/or legacy parking lot lighting systems energized by a 277/480 v transformer. The forgoing issues are exacerbated in the event a mixed Level 2 and Level 3 charging environment is desired.

Fifth, utilization of EV chargers commonly requires cellular connectivity between the charger and an internet-hosted charger controller network, increasing carried by first-net and similar first-responder cellular networks, as well as cellular connectivity in the consumer/commercial bands for vehicle owners to access the chargers via cloud service; whereas, cellular connectivity in concrete, underground, or remote parking facilities may be unavailable or of poor signal strength.

Sixth, present-day charging environments in the United States are dependent on fixed-cord assemblies rather than as socket-based solution requiring vehicle-mounted cords and or portable charging cords that drivers must own, maintain, and safely position to couple their vehicle with the charging equipment. This results in the charging systems operator incurring the costs of maintenance and repair of a vulnerable fixed charging cord and coupler, incur the costs of replacement parts due to increasingly common cord theft arising from the value of the copper conductors, and liability in the event a misused or disabled corded system causes personal injury or property damage. The reason this technology is not available in the US, as opposed to other nations, is due in part to the prevailing 120/208/277/480 common voltages made available by utilities.

Accordingly, there is need for an integrated solution housing the foregoing auxiliary components, assemblies, and voltage transformation equipment necessary to position, maintain, operate, and fund the electric vehicle charging ecosystem. The invention uniquely addresses all of the foregoing problems, and particularly, can facilitate more efficient, universal, and ubiquitous charging when limited to a sub-optimal voltage power source, or where a site owner desires to install a variety of equipment quickly, utilize minimum space, limit visibility of conventional equipment assemblies, mitigate exposure to hardware, installation, maintenance, and operating costs, and/or where mobile internet is lacking.

### SUMMARY OF THE INVENTION

Accordingly, embodiments of the invention are directed to enhancing Level 1, Level 2, and Level 3 electric vehicle charger operations in commercial and multi-family installations that substantially obviates one or more of the problems due to limitations and disadvantages of the related art.

An object of embodiments of the invention is to provide the optimal voltage for charging electric vehicles in commercial environments regardless of the voltage available at the site.

Another object of embodiments of the invention is to provide a distribution panel serving electric vehicle chargers that is easily configurable for charging a variety of electric vehicles and can serve as a housing or mounting location for other equipment.

Yet another object of embodiments of the invention is to decrease labor, effort, permits, regulatory restrictions, time and all associated costs and burdens required to erect electric vehicle chargers.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, an electric vehicle charger for commercial installation includes a main body, an electrical usage meter on the main body configured to meter three-phase power, a main three-phase circuit breaker, a transformer in the main body, the transformer configured to step-up the voltage of the three-phase power, and a main single-phase circuit breaker.

In another aspect, an electric vehicle charger for commercial installation includes a main body, an electrical usage meter on the main body configured to meter three-phase power, a main three-phase circuit breaker, a transformer in the main body, the transformer configured to step-up the voltage of the three-phase power, a main single-phase circuit breaker, a single-phase circuit breaker array electrically connected to the transformer for providing electrical power to one or more additional chargers, a charging cord connected to the main body and electrically connected to the transformer, the charging cord configured to deliver electricity to the electric vehicle, a controller connected to the Internet, the controller configured to communicate with a server to authorize payments for use of the charger.

In yet another aspect, charging an electric vehicle charger in a commercial installation includes the steps of providing three-phase power having three legs where each leg having a nominal voltage of 120 volts, connecting two of the legs to a transformer, transforming the two legs from 120 volts to at least 139 volts, and applying the two legs to a charging port of the electric vehicle such that the voltage between the two legs is at least 240 volts and not more than 280 volts.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an isometric view of a rear, side, and top side of a charger for an electric vehicle;

FIG. 2 is a cut-away view of a rear, side, and top side of a charger for an electric vehicle;

FIG. 3 is an isometric view of a front, side, and top side of a charger for an electric vehicle;

FIG. 4 is a cut-away view of a front, side, and top side of a charger for an electric vehicle;

FIG. 5 is a detailed view of an instrument panel of a charger for an electric vehicle;

FIG. 6 is drawing of a hasp-style lockout for a circuit breaker according to an embodiment of the invention; and

FIG. 7 is a process flow chart for charging an electric vehicle according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

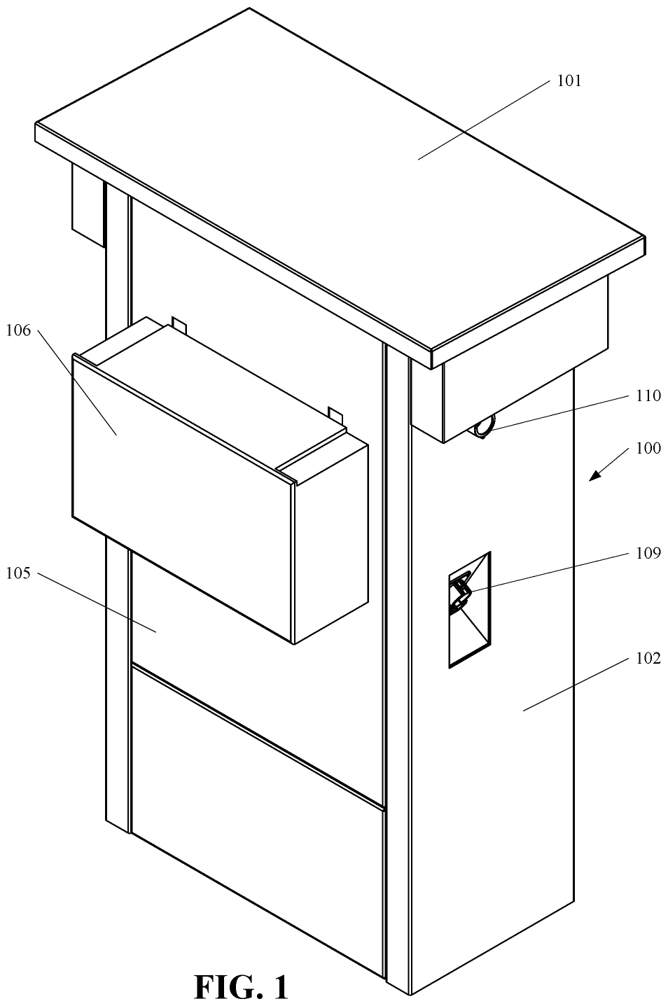

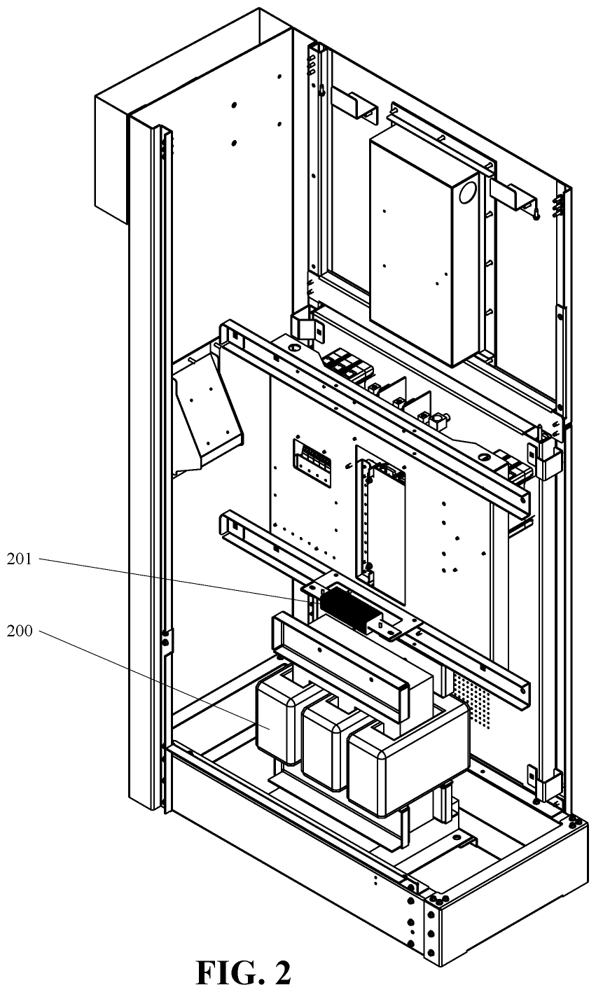

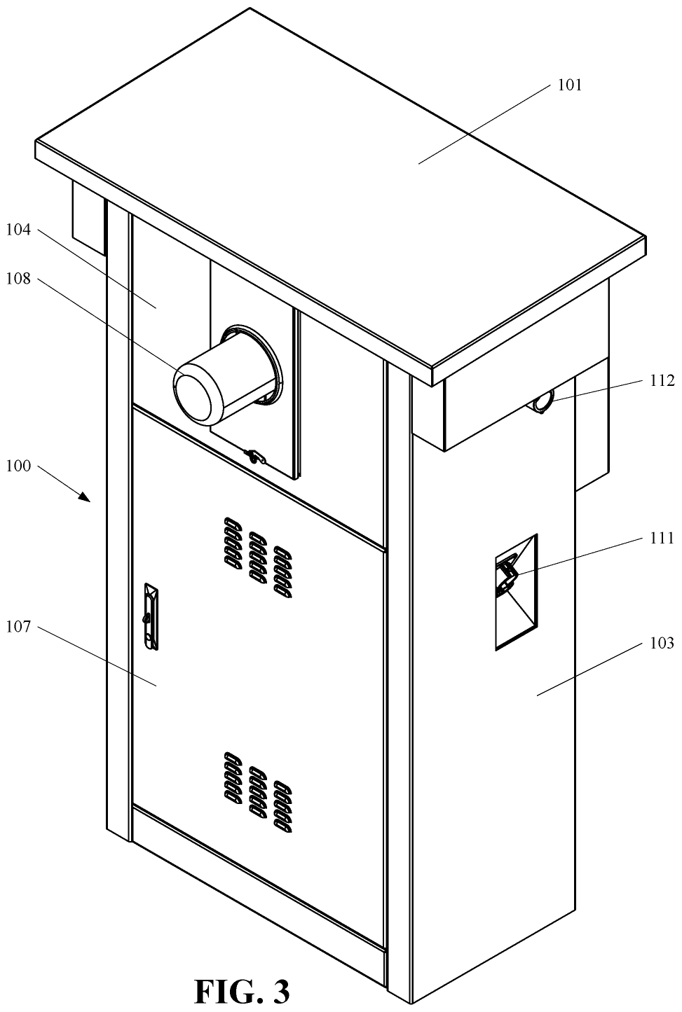

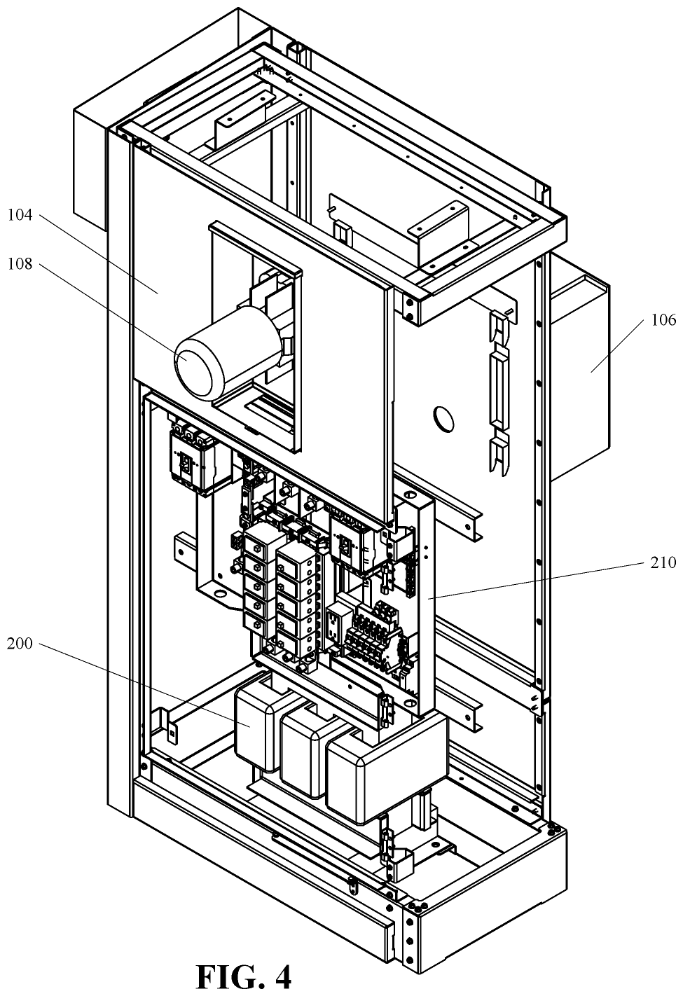

With reference to FIG. 1-FIG. 5, an electric vehicle charger for commercial installation includes a main body 100. The main body has a top 101, first side 102, second side 103, front side 104, and back side 105. The back side 105 can have auxiliary housing 106. The front side 104 can have removable panel 107 and electrical meter 108. The first side 102 can have electrical socket 109 and cable retractor 110. The second side can have electrical socket 111 and cable retractor 112.

The interior of the main body can include a transformer 200, heater 201, and instrument panel 210. The instrument panel 210 can include a primary breaker 211, secondary breaker 214, a first breaker array 217, a second breaker array 218, and a GFI receptacle 219.

The electrical sockets 109 and 111 can be in the form of energized type 2 sockets coupled to charging cables (not shown), or to holster the connectors of an externally mounted charger with fixed charging cables, in both cases, used for transferring electrical power to an electric vehicle. The retractors 110 and 112 can attach to the charging cables to pull the charging cables back to the charger to prevent potential damage to the cables and charging connections. The top 101 can be selectively removable and optionally house low-voltage accessory equipment such as routers, modems, display screens, cellular densification nodes and other accessory equipment.

The components of the instrument panel 210 can be variously installed and arranged to meet the specific needs of a particular installation. In one example, 208 v three-phase electrical power from an electrical utility provider can enter the main body 100 from the bottom and be routed to the electrical meter 108. From the electrical meter 108, three-phase electrical power can be routed to a top side 213 the primary breaker 211. Three-phase electrical power can be routed through the primary breaker 211 out of a bottom side 212 of the primary breaker 211 to transformer 200.

In three phase power, each of the three power legs provide a nominal voltage and each leg is 1/3 of a cycle out of phase from the other legs. The voltage between any leg and ground is simply the voltage of the leg. Because the legs are 1/3 of a cycle out of phase, however, the voltage between any two legs is not the simple sum of the voltages. Instead, the voltage between any two legs (where the legs are the same voltage) is the voltage of one leg multiplied by the square root of three. For example the voltage between legs on three-phase power having 120 v legs is: 120 v*√3=208 v.

The transformer 200 can be selected according to requirements of the location where the charger is to be installed. Where the location has 120/208 v three-phase electrical power, an appropriate transformer can be selected to convert 120/208 v three-phase electrical power into the electrical characteristics desired for the site. Where the location has 277/480 three-phase electrical power, appropriate transformer can be selected to convert 277/480 v three-phase electrical power into the electrical characteristics desired for the site.

In embodiments of the invention, the transformer output voltage is 139 v per leg such that the voltage measured between legs is 240 v corresponding to the generally the expected nominal input voltage for charging an electric vehicle. Electric vehicles, however, are commonly designed to accept a range of input voltages and the transformer in embodiments of the invention may be configured having an output voltage per leg of 139 v, 144 v, 161 v, or voltage in the range of 139 v to 161 v where the voltage between legs is 240 v, 250 v, 280 v, or a voltage in the range of 240 v to 280 v (respectively).

In one embodiment, the transformer 200 can convert 120/208v three-phase electrical power to 240 v three-phase electrical power by stepping up each leg of the three-phase power from 120 v to 139 v. In another embodiment, the transformer 200 can step down 277/480 v three-phase electrical power to 240 v three-phase by stepping down each leg of the three-phase down from 277 v to 139 v. In still another embodiment, the transformer 200 can step down 277/480 v three-phase electrical power to 240 v by stepping down a single 277 v leg to 240 v.

From the transformer 200, 240 v three-phase electrical power can be routed to a bottom side 216 of the secondary breaker 214. 240 v three-phase electrical power can then be routed from the top side 215 of secondary breaker 214 to electrical lugs 220 for the first breaker array 217.

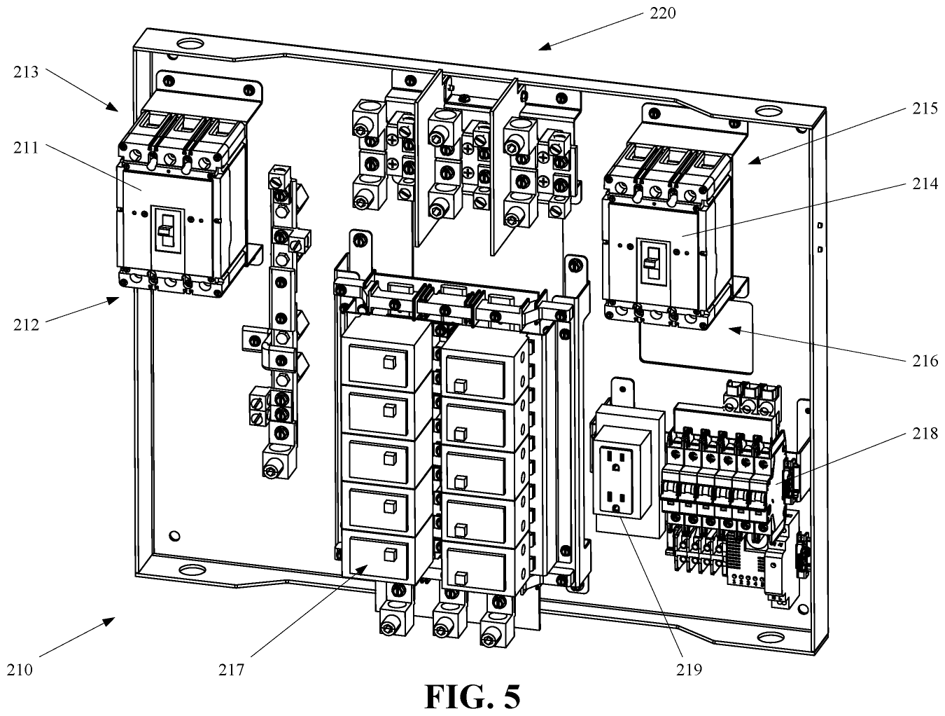

The first breaker array can include nominal 240 v single phase two-pole breakers. The breakers 217 can create 240 v by combining any two 139 v legs of the stepped up/down three-phase electrical power or 277 v single phase to 240 v single phase Line to Neutral. In embodiments of the invention, the electric vehicle charger can be a source of electrical power to ordinary electric vehicle chargers of the related art. In such embodiments, the breakers of the breaker array 217 can act as “mains” for other electric vehicle chargers (not shown). In the illustration of FIG. 5, ten breakers of the array 217 are shown. One of the breakers of the first breaker array 217 can be used to provide electrical power to vehicles connected to electrical sockets 109 or 111. The remaining nine breakers could potentially supply electrical power to nine other electric vehicle chargers. The other electric vehicle chargers could be ordinary simplified electric vehicle chargers without the extensive equipment contained in this exemplary embodiment of the invention. These ordinary chargers can receive the benefits of the invention virtue of being connected to electrical power through the invention. Setup and wiring of these other downstream chargers can be simplified by connection to this invention.

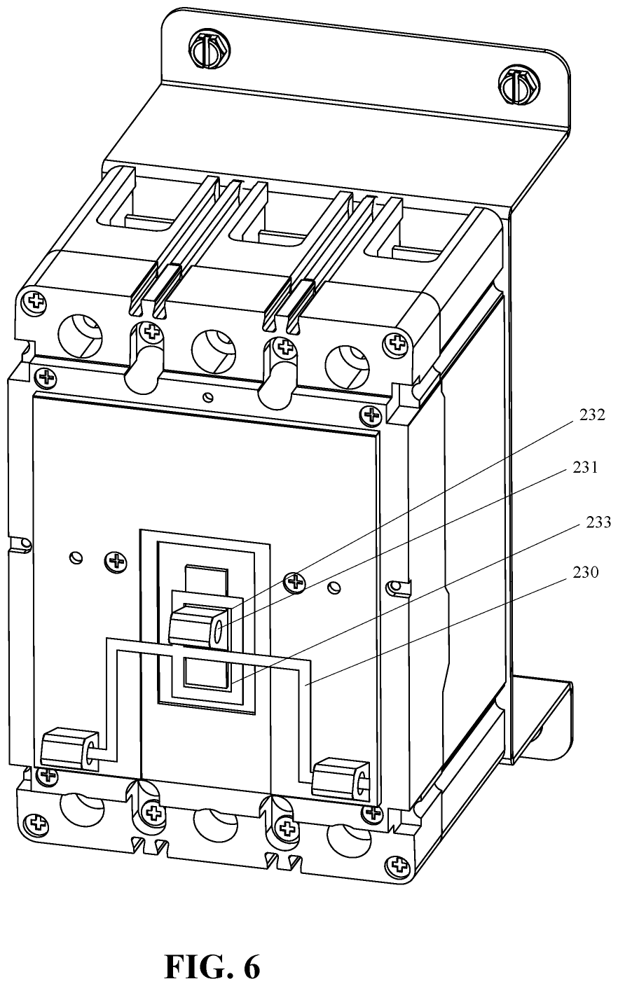

FIG. 6 is drawing of a hasp-style lockout for a circuit breaker according to an embodiment of the invention. With reference to FIG. 6, the breakers described in this invention may optionally include a lockable hasp 230. The lockable hasp 230 can be hingedly attached to the face of a breaker and have a first aperture 232 and second aperture 233. The first and second apertures 232 and 233 can be sized in approximate proportions to receive a switch portion of the breaker in one of an “off” or “on” position. The switch portion of the breaker can have a bore hole 231 through which a lock may be inserted to effectively lock the breaker into one of the first and second apertures 232 and 233. In the instance of the breakers in breaker array 217, it may be desirable to lock a breaker in an “off” position if a technician is servicing an electrical appliance attached to and remote from that breaker. Locking a breaker in the “off” position can prevent another person from unknowingly resetting the breaker and electrocuting the technician.

Referring back to FIG. 1-FIG. 5, electrical power from the bottom 212 of primary breaker 211 can also be routed to second breaker array 218. The second breaker array 218 can include 120 v, single phase breakers. The single-phase breakers can selectively tap any single leg of the 208 v three-phase electrical power to generate 120 v electrical power.

120 v electrical power from the second breaker array 218 can be used to power ordinary equipment that may be useful or beneficial to support the charging of electric vehicles. For example, 120 v electrical power from the second breaker array 218 can be used to power GFI outlet 219. GFI outlet 219 can be used to power tools and instruments used by a technician servicing the invention. Embodiments of the invention can include communications hardware such as routers, modems, and interactive screens (not shown). 120 v electrical power from the second breaker array 218 can provide electrical power to these modems and interactive screens. Interactive screens can provide, for example, an interface to select a charger, an interface to select a charging voltage or charging current; and an interface to pay for charging services.

The invention can include software configured to operate an interactive display, remit/collect payment, and/or access charging services (not shown). The software can operatively configure the interactive display to show information relevant to the charging of electric vehicles such as charge status and charge rate. The software can additionally process electronic payments from users of the electric vehicle charger. The software can monitor the health status of the electric vehicle charger and provide remote debugging capabilities to maintenance technicians and provide for the remote reset of breakers. The software can monitor the current price of electrical power and selectively lower the rate of electrical power when the price of electricity is high. Similarly, the software can receive information from the utility company to temporarily lower the charging rate when other large loads (e.g. large motors or compressors) are activated to prevent from overloading shared electrical lines.

Preferred embodiments of the invention have a hard-wired connection to the Internet such as through cable or fiber and provide a local wifi network. In the event the electric vehicle charger is located underground, in a parking garage, or otherwise in an area of bad cellular service, users can connect to the wifi provided by the electric vehicle charger to interface with the charger for configuration and payment.

The invention can optionally include auxiliary housing 106. Auxiliary housing 106 can house optional, site-specific or application-specific hardware. For example, many electric vehicles are configured to received AC power. Some electric vehicles may be configured to receive DC power. To accommodate DC charging, auxiliary housing 106 may include an AC/DC converter.

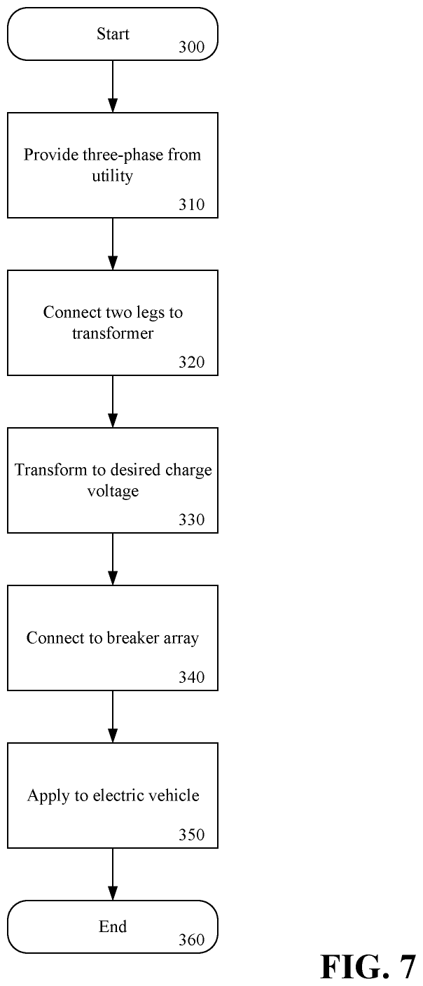

FIG. 7 is a process flow chart for charging an electric vehicle according to an embodiment of the invention. As shown in FIG. 7, the process for charging an electric vehicle can start at process step 300. At process step 310, three phase power from a utility can be provided. The three-phase power can be, for example, 120/208 v or 277/480 v. The three phase power is commonly provided over four conductors where three conductors are hot legs and a fourth conductor is neutral. In 120/208 v three-phase power, there can be three, 120 v legs where each leg is 1/3 of a cycle out of phase from the other two legs.

At process step 320, two of the 120 v legs can be connected to a transformer. The transformer can be selected according to the site requirements for current and voltage. For example, at a large site, a larger transformer may be desirable so there is capacity for increased loads. Additionally, according to site requirements, it may be desirable to increase the voltage from 120 v per leg to 139 v, 144 v, 161 v, or some other voltage. In most instances, it will be desirable to increase the voltage from 120 v to 139 v so that the voltage between two legs is 240 v and matches the nominal voltage expected by many electric vehicles. Although only two legs are described to be transformed, other numbers of legs could be transformed depending on the needs of the site. In some embodiments, all three hot legs are transformed while in other embodiments, only a single leg is transformed.

At process step 330, a transformer can transform the voltage from the provided voltage in step 310 to the configured voltage of the transformer. The voltage between two legs after transforming is ideally 240 v but could be 250 v, 280 v, or in a range between 240 v and 280 v.

At process step 340, the electrical power transformed in step 330 can be provided to a circuit breaker array such as breaker array 217 of FIG. 5. This process step is optional for embodiments of the invention having downstream vehicle chargers that may use electrical power transformed by this process. Power from the breaker array can power, for example, ordinary electric vehicle chargers that do not have the novel features of the invention.

At process step 350, the electrical power transformed in step 330 can be applied to the charging port of an electric vehicle. In process step 360 the process can end.

There are multiple benefits to the invention over the related art. First, electric vehicle chargers in commercial environments are commonly operated on 208 v three-phase power. Electric vehicles, however, are optimally charged on 240 v power as is commonly found in the residential settings. Accordingly, level 2 chargers in commercial environments are underpowered resulting in slower charging. The invention adds a transformer in the base of the housing to increase the voltage from 208 v to 240 v. Additionally, many electric vehicles can accommodate voltages from 250 v to 280 v or even higher. Embodiments of the invention can step up the voltage from 208 v to 250 v or more further increasing charging speed.

Second, related art electric vehicle chargers are not optimized for the reality of infrastructure installation. Many electric vehicle chargers are powered directly from the utility pole. In these instances, a meter must be installed so the electric utility can measure usage. The installation of a meter commonly requires a concrete pad and an electrical box to house the meter. By locating the electric meter in the housing of the invention, the additional pad and electrical box are saved. Additionally, related art electric vehicle chargers are not sized in sufficient proportions to house a transformer of sufficient size to step up the voltage as contemplated by the invention. Thus, to use a transformer in conjunction with related art chargers would require yet another concrete pad and electrical box to house the transformer. Collectively, these additional structures cost money, require labor to install and interconnect, require engineers to specify, design, and review plans, require permits and approvals, and require more maintenance. Embodiments of the invention combine these components into a single, pre-configured and field-reconfigurable housing thereby speeding the installation of electric vehicle chargers.

Although an embodiment of the invention was shown and described in conjunction with the foregoing figures, other configurations are contemplated and therefore within the scope of the invention. For example, while the example contemplates receiving 208 v three-phase power, it is possible that in a specific installation, that 240 v power is available from an existing building electrical panel. In these circumstances, the electrical meter 108, transformer 200, and primary breaker 211 could be omitted and the 240 v electrical power could be routed directly to electrical lugs 220 for the first breaker array 217.

In another example, instead of receiving 208 v three-phase electrical power, the invention can optionally receive 277/480 v three-phase electrical power. In this case, the primary breaker 211 and transformer 200 could be substituted for compatible hardware.

The circuit breakers of the invention can optionally include non-removable circuit lockout devices to physically prevent movement of the corresponding breaker such as described in conjunction with FIG. 6.

Embodiments of the invention can have a screen mounted on the disp

It will be apparent to those skilled in the art that various modifications and variations can be made in the electric vehicle charger for commercial installation without departing from the spirit or scope of the invention. Thus, it is intended that embodiments of the invention cover the modifications and variations of this invention provided they come within the scope of the appended claims and their equivalents.

What is claimed is:

1. A charger for an electric vehicle suitable for commercial installation comprising:
a main body;
an electrical usage meter on the main body configured to meter three-phase power;
a main three-phase circuit breaker;
a transformer in the main body, the transformer configured to step-up the voltage of the three-phase power; and
a main single-phase circuit breaker.

2. The charger for an electric vehicle of claim 1 further comprising:
a charging cord connected to the main body and electrically connected to the transformer, the charging cord configured to deliver electricity to the electric vehicle.

3. The charger for an electric vehicle of claim 2 further comprising:
a retractor cable connected to the main body and the charging cord.

4. The charger for an electric vehicle of claim 1 further comprising:
a controller connected to the Internet, the controller configured to communicate with a server to authorize payments for use of the charger.

5. The charger for an electric vehicle of claim 1 further comprising:
a single-phase circuit breaker array electrically connected to the transformer for providing electrical power to one or more additional chargers.

6. The charger for an electric vehicle of claim 5 further comprising:
a first breaker of the single-phase circuit breaker array; and
a lockable hasp on the first breaker.

7. The charger for an electric vehicle of claim 1 further comprising:
an AC to DC converter.

8. The charger for an electric vehicle of claim 1 wherein the transformer is configured to step-up the voltage of at least two legs of the three-phase power from approximately 120 volts each to approximately 139 volts each.

9. The charger for an electric vehicle of claim 1 wherein the transformer is configured to step-up the voltage of at least at least two legs of the three-phase power to at least 144 volts.

10. The charger for an electric vehicle of claim 1 wherein the transformer is configured to step-up the voltage of at least at least two legs of the three-phase power to at least 161 volts.

11. The charger for an electric vehicle of claim 1 wherein the transformer is configured to step-up the voltage of at least at least two legs of the three-phase power to a voltage between 144 volts and 161 volts.

12. The charger for an electric vehicle of claim 1 wherein the voltage between two of the legs of the stepped-up three phase power is at least 240 volts.

13. The charger for an electric vehicle of claim 1 wherein the voltage between two of the legs of the stepped-up three phase power is at least 250 volts.

14. The charger for an electric vehicle of claim 1 wherein the voltage between two of the legs of the stepped-up three phase power is not more than 280 volts.

15. A charger for an electric vehicle suitable for commercial installation comprising:
a main body;
an electrical usage meter on the main body configured to meter three-phase power;
a main three-phase circuit breaker;
a transformer in the main body, the transformer configured to step-up the voltage of the three-phase power;
a main single-phase circuit breaker;
a single-phase circuit breaker array electrically connected to the transformer for providing electrical power to one or more additional chargers;
a charging cord connected to the main body and electrically connected to the transformer, the charging cord configured to deliver electricity to the electric vehicle;
a controller connected to the Internet, the controller configured to communicate with a server to authorize payments for use of the charger.

16. The charger for an electric vehicle of claim 15 wherein the transformer is configured to step-up the voltage of at least two legs of the three-phase power from approximately 120 volts each to approximately 139 volts each.

17. The charger for an electric vehicle of claim 15 wherein the voltage between two of the legs of the stepped-up three phase power is at least 240 volts and does not exceed 280 volts.

18. The charger for an electric vehicle of claim 15 further comprising:
a first breaker of the single-phase circuit breaker array;
a lockable hasp on the first breaker; and
at least one additional electric vehicle charger electrically connected to the first breaker.

19. A method for charging an electric vehicle comprising:
providing three-phase power having three legs where each leg having a nominal voltage of 120 volts;
connecting two of the legs to a transformer;
transforming the two legs from 120 volts to at least 139 volts; and
applying the two legs to a charging port of the electric vehicle such that the voltage between the two legs is at least 240 volts and not more than 280 volts.

20. The method of claim 19 further comprising:
connecting the two legs to a breaker array, wherein a first breaker of the array is connected to a second electric vehicle charger.
